(19) United States
(12) Patent Application Publication
(10) Pub. No.: US 2007/0247644 A1
(43) Pub. Date: Oct. 25, 2007

(54) Image processing system

(76) Inventor: Keiichi Tsumura, Hyogo (JP)

Correspondence Address: MCDERMOTT WILL & EMERY LLP, 600 13TH STREET, NW, WASHINGTON, DC, 20005-3096, US

(21) Appl. No.: 11/783,651

(22) Filed: Apr. 11, 2007

(30) Foreign Application Priority Data
Apr. 25, 2006 (JP) 2006-120961

(51) Int. Cl. G06K 15/02; G06F 15/00

(52) U.S. Cl. 358/1.2

(57) ABSTRACT

The image processing system of the present invention comprises: a built-in type memory in which the number of bits per address is L×M×N bits or more, where L is an integer of 1 or larger, M is an integer of 2 or larger, and N is an integer of 2 or larger; and a bit rearranging part which performs rearrangement of bits within a same address by a set of L-bits, in order to perform inversion or rotation of an image data of M×N pixels on either of the data writing side or the data readout side of the memory part, or on both of those sides.

### BACKGROUND OF THE INVENTION

1. Field of the Invention

The present invention relates to an image processing system that performs inversion, rotation, etc. of image data at a high speed by using a memory.

2. Description of the Related Art

There are digital still cameras, video cameras, television sets, and the like, as video devices for handling image data. Among those apparatuses, there are the ones that are equipped with a function of inverting or rotating the image data by using a memory.

As an example, Japanese Published Patent Literature (Japanese Unexamined Patent Publication 2005-109967) discloses a conventional structure that inverts and rotates image data by using a memory. In this structure, an external SDRAM is used as a memory, and addressing is devised so as to be less change in row addresses.

The conventional structure that inverts and rotates image data by using a memory is mainly based on the premise that SDRAM is used. Since the bus width for the data in an SDRAM is as small as about 32 bits at the maximum, high-speed processing cannot be performed. Incidentally, eDRAM (mixed DRAM) is being used lately. The eDRAM is internally provided in an LSI, so that no bus is required as an external terminal. Therefore, a large bus width for the data can be secured.

### SUMMARY OF THE INVENTION

The main object of the present invention therefore is to achieve high-speed processing for inverting and rotating the image data through using a function of a built-in type memory such as an eDRAM that is capable of securing a large bus width for the data.

In order to solve the aforementioned issues, the image processing system of the present invention comprises:

a built-in type memory in which the number of bits per address is L×M×N bits or more, assuming that L is an integer of 1 or larger, M is an integer of 2 or larger, and N is an integer of 2 or larger; and

a bit rearranging part which performs rearrangement of bits within a same address by a set of L-bits, in order to perform inversion or rotation of image data of M×N pixels either on a data writing side or on a data readout side of the memory part, or on both of those sides.

The L-bits indicate luminance signal, color signal, or a combination of a luminance signal and a color signal.

According to the image processing system of the present invention, by using the built-in type memory part so as to be able to secure a large bus width for the data, inversion and rotation of the image data can be performed at a high speed.

By utilizing a built-in type memory such as eDRAM that can secure a large width of bus, it is possible according to the image processing system of the present invention to perform inversion and rotation of the image data at a high speed.

The present invention is effective as an image processing system that inverts and rotates image data by using a memory, in video devices such as digital still cameras, video cameras, and television sets.

### BRIEF DESCRIPTION OF THE DRAWINGS

Other objects of the present invention will become clear from the following description of the preferred embodiments and the appended claims. Those skilled in the art will appreciate that there are many other advantages of the present invention by embodying the present invention.

FIG. 1 is a block diagram of an image processing system according to an embodiment of the present invention;

FIG. 2 is a schematic constitutional diagram of an input-side bit rearranging part according to the embodiment of the present invention;

FIG. 3 is a schematic constitutional diagram of an output-side bit rearranging part according to the embodiment of the present invention;

FIG. 4 is a schematic constitutional diagram of an output format converting part according to the embodiment of the present invention;

FIG. 5A-FIG. 5E are illustrations for the operations of the case without inversion and rotation according to the embodiment of the present invention;

FIG. 6A-FIG. 6E are illustrations for the operations of the case of performing right-and-left inversion according to the embodiment of the present invention;

FIG. 7A-FIG. 7E are illustrations for the operations of the case of performing right-and-left inversion according to the embodiment of the present invention;

FIG. 8A-FIG. 8E are illustrations for the operations of the case of performing 90-degree rotation according to the embodiment of the present invention;

FIG. 9A-FIG. 9E are illustrations for the operations of the case of performing 90-degree rotation according to the embodiment of the present invention;

FIG. 10 is an illustration showing Y data of 8 bits as black-and-white data;

FIG. 11 is an illustration showing color YUV data of 16 bits as color data;

FIG. 12 is an illustration showing color RGB data of 16 bits as color data;

FIG. 13 is a block diagram of an image processing system according to a modification example of the present invention;

FIG. 14 is a block diagram of an image processing system according to another modification example of the present invention;

FIG. 15 is a block diagram of an image processing system according to yet another modification example of the present invention;

FIG. 16 is an illustration for the effect of image processing performed in the modification example shown in FIG. 15;

FIG. 17 is a block diagram of an image processing system according to yet another modification example of the present invention;

FIG. 18 is an illustration for describing the addresses according to the modification example shown in FIG. 17;

FIG. 19 is a block diagram of an image processing system according to another modification example of the present invention;

FIG. 20 is an illustration for the addresses according to the modification example shown in FIG. 19;

FIG. 21A-FIG. 21E are illustrations for the operations of the case without inversion and rotation according to the modification example of the present invention shown in FIG. 19;

FIG. 22A-FIG. 22E are illustrations for the operations of the case of performing right-and-left inversion according to the aforementioned modification example of the present invention;

FIG. 23A-FIG. 23E are illustrations for the operations of the case of performing right-and-left inversion according to the aforementioned modification example of the present invention;

FIG. 24A-FIG. 24E are illustrations for the operations of the case performing 90-degree rotation according to the aforementioned modification example of the present invention; and

FIG. 25A-FIG. 25E are illustrations for the operations of the case of performing 90-degree rotation according to the aforementioned modification example of the present invention.

### DETAILED DESCRIPTION OF THE INVENTION

Hereinafter, a video device that comprises an image processing system and an image capturing part according to an embodiment of the present invention will be described in detail referring to the accompanying drawings. A video device 100 of this embodiment comprises an image data acquisition unit 100A and an image processing system 100B. The image data acquisition unit 100A is constituted with an image pickup device and a video data receiving device. The image processing system 100B comprises an input-side bit rearranging part 100, a built-in type memory part 102 such as eDRAM or SRAM, an output-side bit rearranging part 103, and an output format converting part 104. The built-in type memory part 102 means a memory device that is provided within an LSI which constitutes the image processing system 100B.

Input image data S1 of L×M×N bits is inputted to the input-side bit rearranging part 101 in order of line process by one pixel per CLK. The input-side bit rearranging part 101 performs bit rearranging processing to the input image data S1 by a set of L-bits, and outputs it as writing data S2. There are also cases where the input-side bit rearranging part 101 outputs it as writing data S2 without performing bit rearranging processing. Such input bit rearranging processing is carried out according to an input rearrangement selection signal that is supplied to the input-side bit rearranging part 101 from outside (such as an image processing control part or the like, not shown). Here, “L” indicates the number of bits per pixel, “M” is the number of horizontal pixels, and “N” is the number of vertical pixels.

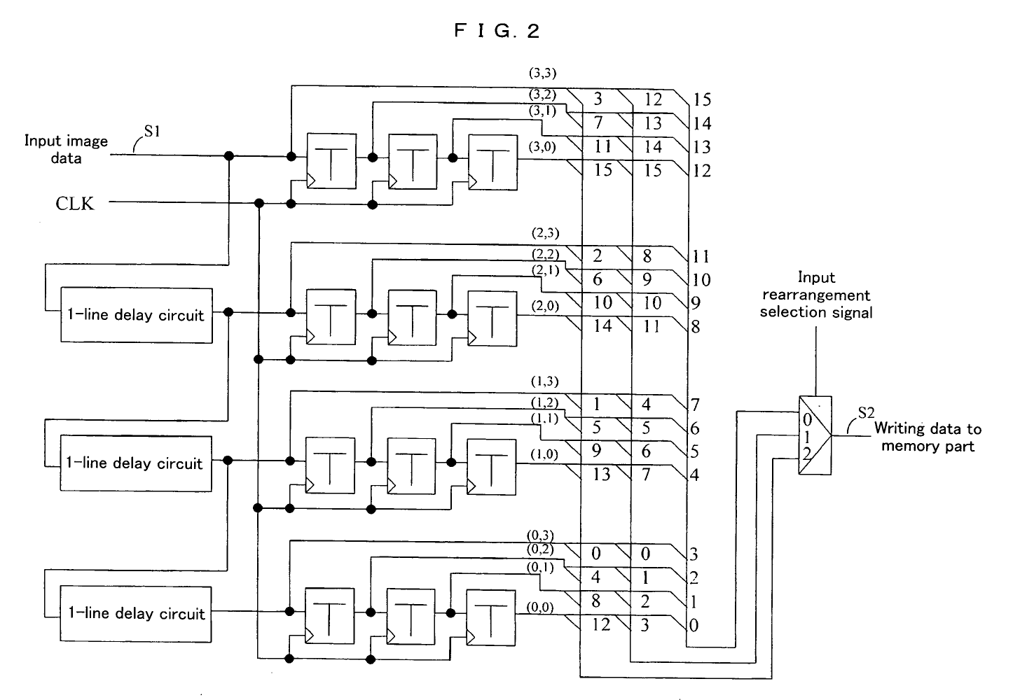

FIG. 2 shows a schematic constitutional diagram of the input-side bit rearranging part 101. In FIG. 2, as an example, it is assumed that horizontal 4-pixels×vertical 4-pixels are corresponded to a single address on the memory part 102, and the input image data is inputted by one pixel per CLK in order of line process. The number on the left within parentheses shown below indicates the vertical coordinate of the horizontal 4-pixels×vertical 4-pixels, and the number on the right indicates the horizontal coordinate of the horizontal 4-pixels×vertical 4-pixels. The numerical values 0-15 in FIG. 2 correspond to the coordinates (0, 0)-(3, 3).

First, the input image data Si is inputted to the input-side bit rearranging part 101 in order of (0, 0), (0, 1), (0, 2), (0, 3). Then, after a delay of one line, the input image data S1 is inputted to the input-side bit rearranging part 101 in order of (1, 0), (1, 1), (1, 2), (1, 3). Subsequently, after a delay of one line, the input image data Si is inputted to the input-side bit rearranging part 101 in order of (2, 0), (2, 1), (2, 2), (2, 3). Thereafter, after a delay of one line, the input image data S1 is inputted to the input-side bit rearranging part 101 in order of (3, 0), (3, 1), (3, 2), (3, 3).

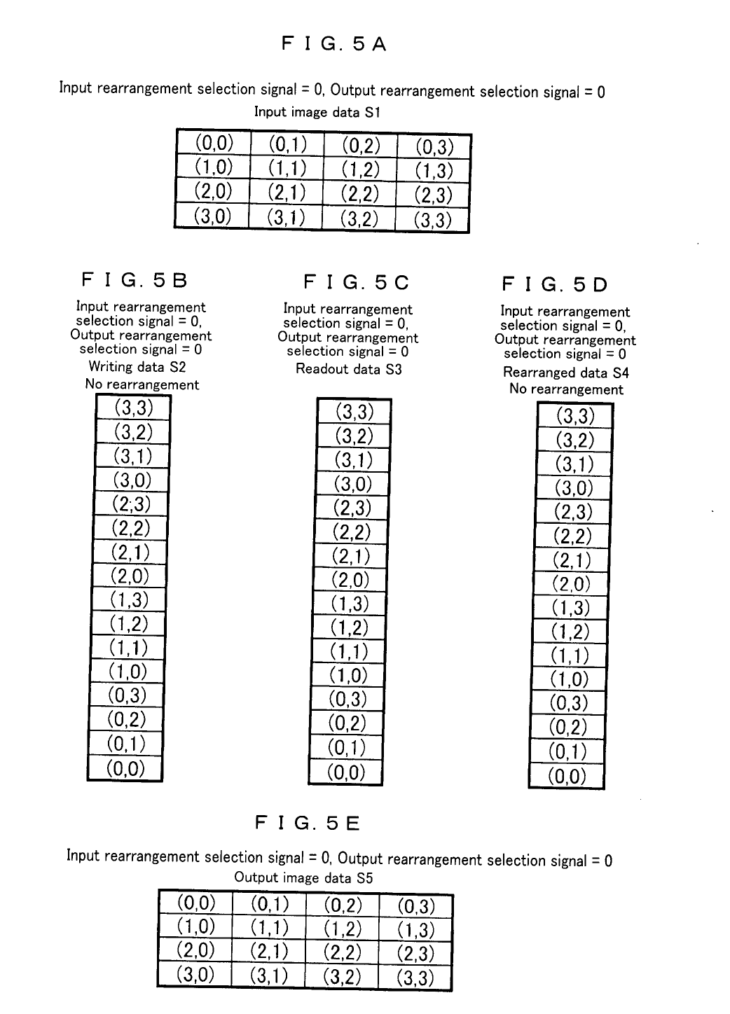

When the input rearrangement selection signal is 0 at the point where the last input image data S1, i.e. (3, 3), is inputted to the input-side bit rearranging part 101, data without inversion processing and rotation processing can be obtained as the writing data S2. When the input rearrangement selection signal is 1, data to which right-and-left inversion processing is performed is obtained as the writing data S2. Further, when the input rearrangement selection signal is 2, data that is rotated by 90 degrees is obtained as the writing data S2. The inversion processing and the rotation processing will be described later in detail referring to FIG. 5-FIG. 9.

In the memory part 102, the writing data S2 of L×M×N bits is written to a single address, and readout data S3 of L×M×N bits is read out from a single address. As an example, the writing data S2 is the data of horizontal 4-pixels×vertical 4-pixels, and it is collectively written to a single address of the memory part 102. Then, after completing the processing such as accessing to other addresses, the data of horizontal 4-pixels×vertical 4-pixels is collectively read out from a single address of the memory part 102. This is the readout data S3.

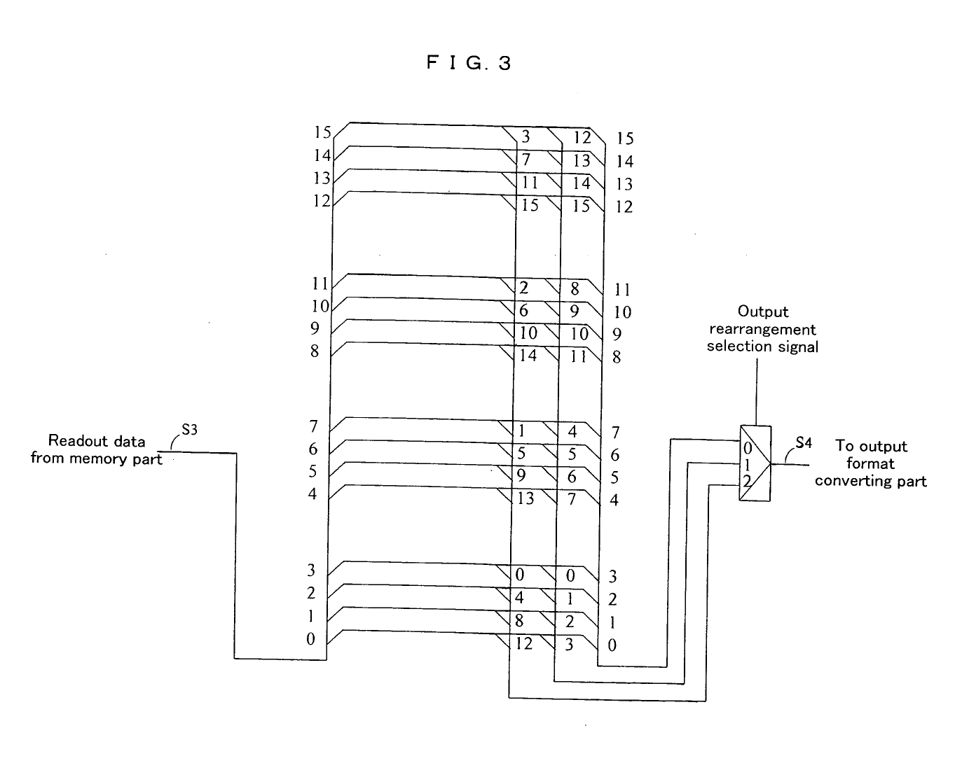

The output-side bit rearranging part 103 performs bit rearranging processing to the readout data S3 by a set of L-bits, and outputs it as rearranged data S4. There are also cases where the output-side bit rearranging part 103 outputs it as the rearranged data S4 without performing the bit rearranging processing. Such output bit rearranging processing is carried out according to an output rearrangement selection signal that is supplied to the output-side bit rearranging part 103 from out side (such as an image processing control part or the like, not shown). FIG. 3 shows a schematic constitutional diagram of the output-side bit rearranging part 103.

When the output rearrangement selection signal is 0, the rearranged data S4 without rotation processing and inversion processing can be obtained. When the output rearrangement selection signal is 1, the rearranged data S4 to which the right-and-left inversion processing is performed can be obtained. Further, when the output rearrangement selection signal is 2, the rearranged data S4 that is rotated by 90 degrees can be obtained.

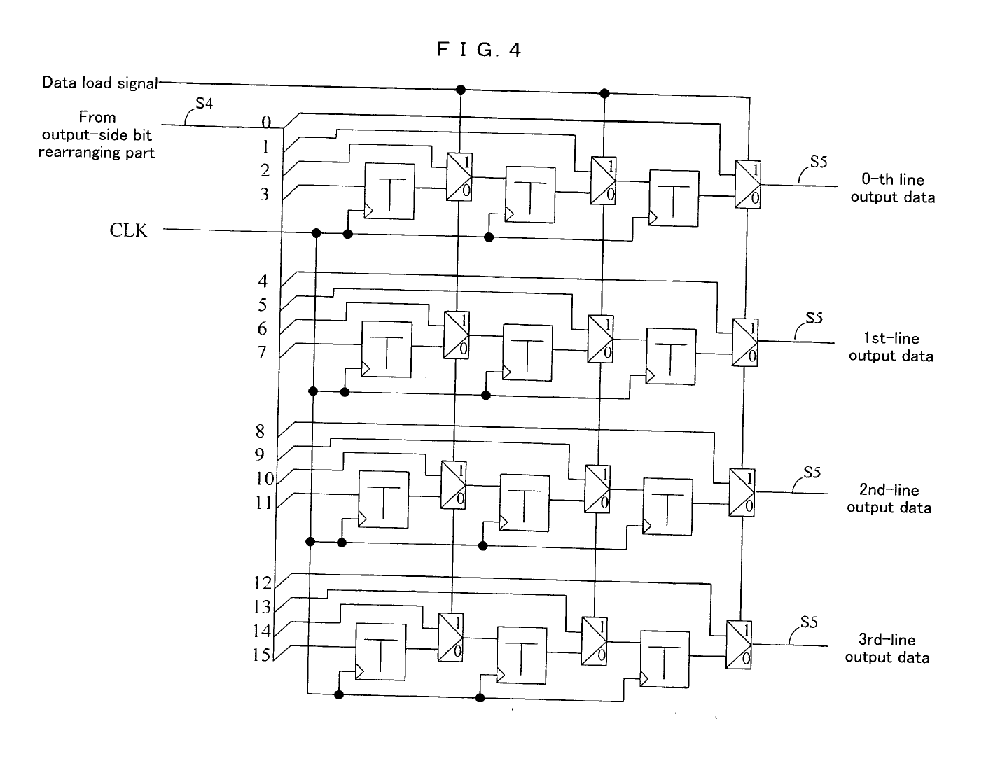

The output format converting part 104 converts the output format of the rearranged data S4 that is outputted from the output-side bit rearranging part 103, and outputs it as output image data S5. FIG. 4 shows a schematic constitutional diagram of the output format converting part 104. After the readout data S3 of horizontal 4-pixels×vertical 4-pixels is outputted simultaneously, it is rearranged by the output-side bit rearranging part 103, and the rearranged data S4 is generated. The rearranged data S4 is inputted to the output format converting part 104. The output format converting part 104 converts the rearranged data S4 in such ma manner that the data of one pixel is outputted per CLK. The conversion is carried out in each line separately. The data load signal is a signal that becomes 1 when the output format converting part 104 receives the rearranged data S4 from the output-side bit rearranging part 103, and becomes 0 in other cases. Assuming that the data of horizontal 4-pixels×vertical 4-pixels is outputted once in four CLKs, the data load signal becomes 1 only during the time of 1 CLK when the rearranged data S4 is received from the output-side bit rearranging part 103, and becomes 0 during the time of the next three CLKs. This action is repeatedly carried out. Herewith, the output image data S5 of one pixel and four lines per CLK is outputted sequentially from the output format converting part 104.

Referring to FIG. 5A-FIG. 9A, operations of the case with or without both the inversion processing and rotation processing will be described in a specific manner. First, referring to FIG. 5, described will be the operation of the case without right-and-left inversion processing and rotation processing. FIG. 5A shows the input image data S1 of horizontal 4-pixels×vertical 4-pixels. In this case, since the input rearrangement selection signal is 0, the writing data S2 is written to the memory part 102 as the data of 16 pixels without receiving the rearranging processing, as shown in FIG. 5B. Meanwhile, because the output rearrangement selection signal is also 0 as shown in FIG. 5C and FIG. 5D, the readout data S3 does not receive the rearranging processing from the output-side bit rearranging part 103 (see FIG. 5D). Therefore, the readout data S3 and the rearranged data S4 become the same. Thereafter, the output format conversion is performed to the rearranged data S4 by the output format converting part 104, and thereby the output image data S5 is obtained (see FIG. 5E). The input image data S1 and the output image data S5 become the same image data to which neither the inversion processing nor the rotation processing is carried out.

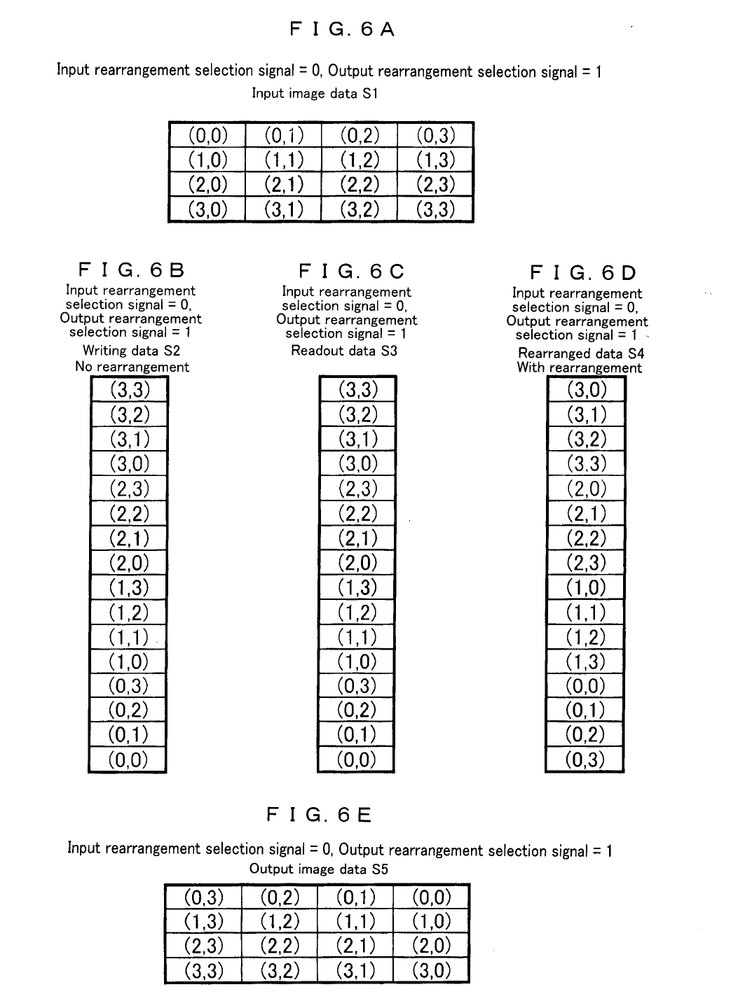

Next, referring to FIG. 6A-FIG. 6E, described will be the operation of the case with right-and-left inversion processing, without writing data rearranging processing, and with readout data rearranging processing. FIG. 6A shows the input image data S1 of horizontal 4-pixels×vertical 4-pixels. In this case, since the input rearrangement selection signal is 0 as shown in FIG. 6B, the writing data S2 is written to the memory part 102 as the data of 16 pixels without receiving the rearranging processing. Meanwhile, since the output rearrangement selection signal is also 1 as shown in FIG. 6C and FIG. 6D, the readout data S3 receives the rearranging processing of right-and-left inversion. Therefore, the rearranged data S4 becomes a relationship inversed in terms of right and left sides with respect to the readout data S3. Thereafter, the output format conversion is performed to the rearranged data S4 by the output format converting part 104, and thereby the output image data S5 is obtained (see FIG. 6E). The output image data S5 becomes the image data that is inversed in terms of right and left sides with respect to the input image data S1.

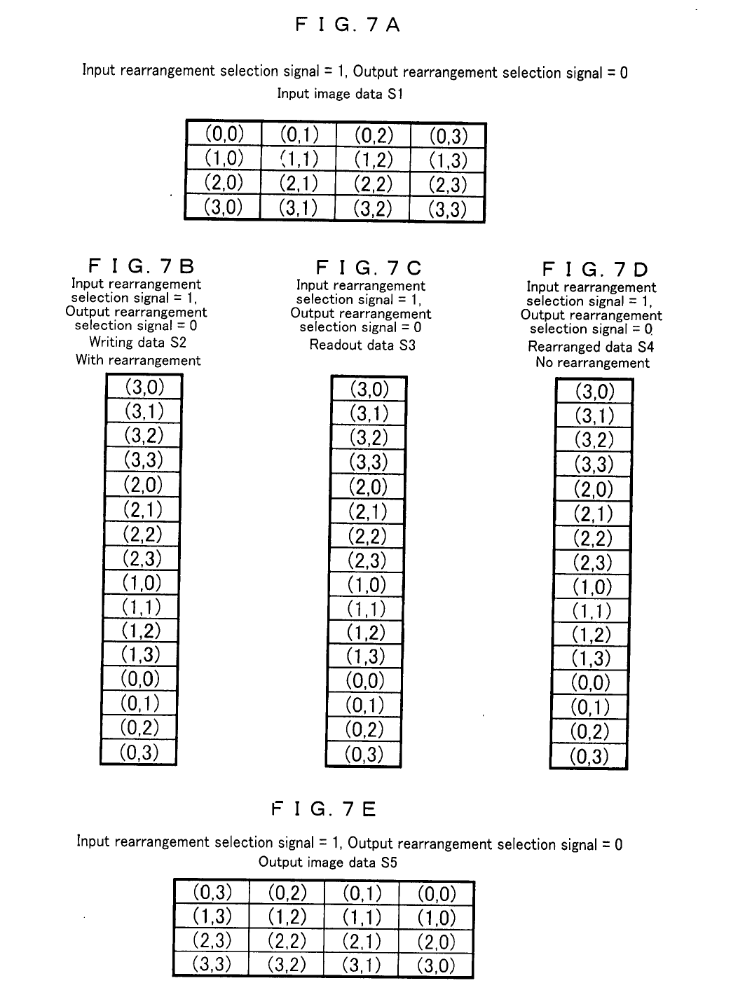

Next, referring to FIG. 7A-FIG. 7E, described will be the operation of the case with right-and-left inversion processing, with writing data rearranging processing, and without readout data rearranging processing. FIG. 7A shows the input image data S1 of horizontal 4-pixels×vertical 4-pixels. Since the input rearrangement selection signal is 1, the rearranging processing of right-and-left inversion is performed to the writing data S2. Then, as shown in FIG. 7B, the rearranging-processed writing data S2 is written to the memory part 102 as the data of 16 pixels. Because the output rearrangement selection signal is also 0 as shown in FIG. 7C, the rearranging processing is not performed to the readout data S3. Therefore, the readout data S3 and the rearranged data S4 become the same. Thereafter, the output format conversion is performed to the rearranged data S4 by the output format converting part 104, and thereby the output image data S5 shown in FIG. 7E is obtained. The output image data S5 becomes the image data that is inversed in terms of right and left sides with respect to the input image data S1.

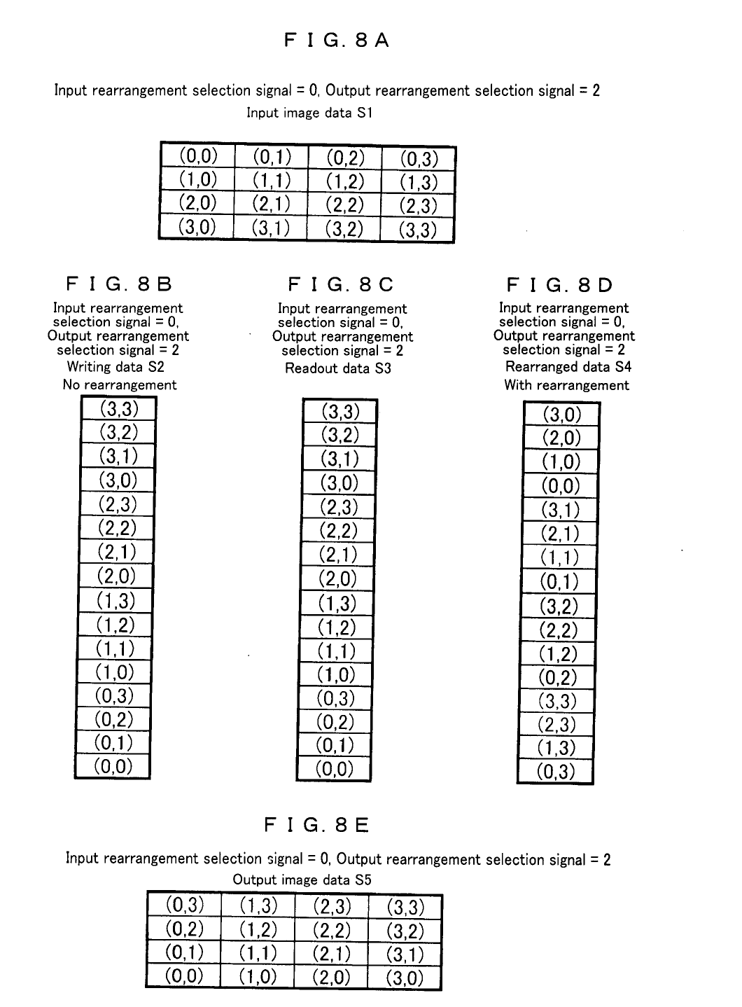

Next, referring to FIG. 8A-FIG. 8E, described will be the operation of the case with 90-degree rotation processing, without writing data rearranging processing, and with readout data rearranging processing. FIG. 8A shows the input image data S1 of horizontal 4-pixels×vertical 4-pixels. Since the input rearrangement selection signal is 0, the writing data S2 is written to the memory part 102 as the data of 16 pixels without receiving the rearranging processing as shown in FIG. 8B. As shown in FIG. 8C, the readout data S3 becomes the same as the writing data S2. Because the output rearrangement selection signal is 2 as shown in FIG. 8D, the rearranged data S4 receives the 90-degree rotation processing. Therefore, the readout data S3 and the rearranged data S4 have a relationship rotated by 90 degrees from each other. Thereafter, by performing the output format conversion to the rearranged data S4 by the output format converting part 104, the output image data S5 shown in FIG. 8E is obtained. The output image data S5 becomes the image data that is rotated by 90 degrees from the input image data S1.

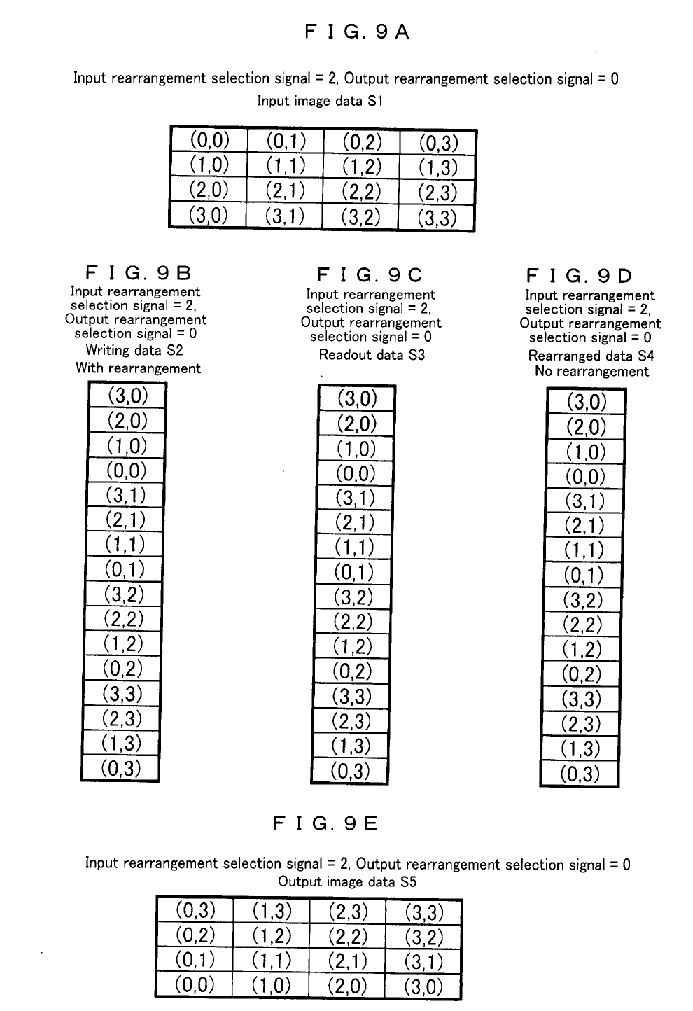

Next, referring to FIG. 9A-FIG. 9E, described will be the operation of the case with 90-degree rotation processing, with writing data rearranging processing, and without readout data rearranging processing. FIG. 9A shows the input image data S1 of horizontal 4-pixels×vertical 4-pixels. Because the input rearrangement selection signal of the input-side bit rearranging part 101 is 2 as shown in FIG. 9B, the writing data S2 after receiving the rearranging processing of 90-degree rotation is written to the memory part 102 as the data of 16 pixels. Since the output rearrangement selection signal is 0 as shown in FIG. 9C and FIG. 9D, the rearranging processing is not performed to the readout data S3. Therefore, the readout data S3 becomes the same as the rearranged data S4. Thereafter, the output format conversion is performed to the rearranged data S4 by the output format converting part 104, and thereby the output image data S5 shown in FIG. 9E is obtained. The output image data S5 becomes the image data that is rotated by 90 degrees from the input image data S1.

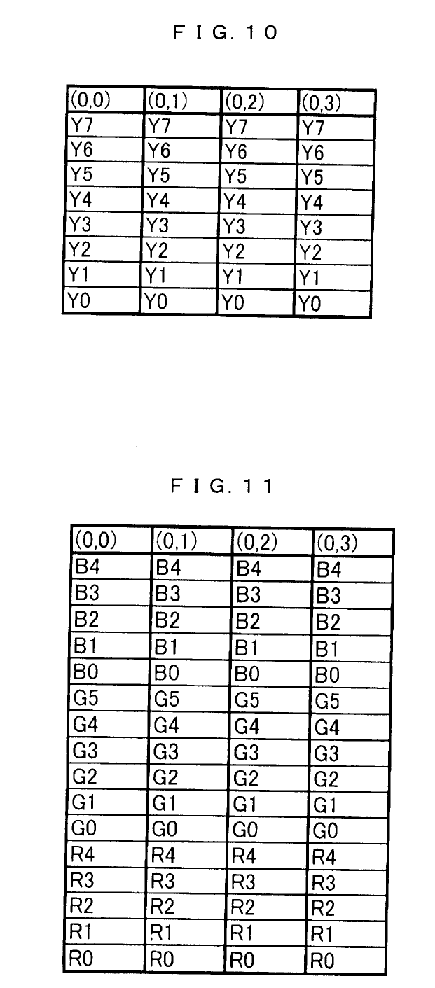

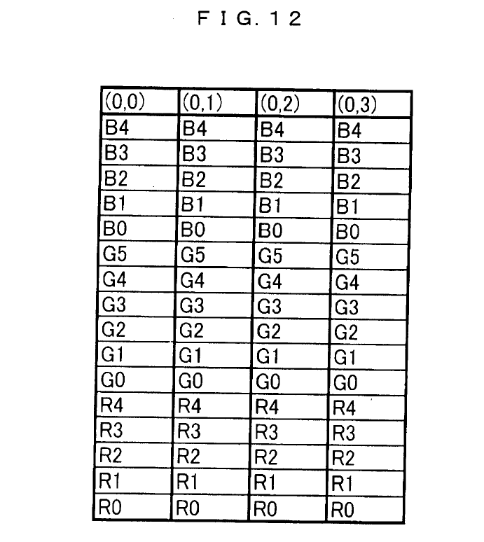

Furthermore, the data of L-bits may be black-and-white data of an image or color data of an image. As an example of the black-and-white data, FIG. 10 shows the Y data of 8 bits. L-bits of the respective pixels (0, 0), (0, 1), (0, 2), (0, 3) are constituted with 8 bits of luminance signals Y0-Y7, which corresponds to the case where the L-bits in claim 2 indicate the luminance signals. Further, as an example of the color data, FIG. 11 shows the color YUV data of 16 bits. L-bits of the respective pixels (0, 0), (0, 1), (0, 2), (0, 3) are constituted with 16 bits of Y0-Y7, U0-U7 (or V0-V7), and Y is the data of two pixels (0, 0), (0, 1), whereas U is the data of one pixel (0, 0), and V is the data of one pixel (0, 1). “YUV” is a form of expressing the colors by three kinds of information, i.e. a luminance signal (Y), a difference between the luminance and a blue component (U), and a difference between the luminance signal and a red component (V). This corresponds to the case where the L-bits in claim 2 indicate a combination of the luminance signal and the color signal. Furthermore, as an example of the color data, FIG. 12 shows the color RGB data of 16 bits (the case of RGB565 data). L-bits of the respective pixels (0, 0), (0, 1), (0, 2), (0, 3) are constituted with 16 bits of red R0-R4, green G0-G5, and blue B0-B5, which corresponds to the case where the L-bits in claim 2 indicate the color signals.

According to the image processing system constituted in this manner, a large bus width can be secured for the data by using the built-in type memory part 102. Therefore, the image data can be inverted or rotated at a high speed.

### MODIFICATION EXAMPLE 1

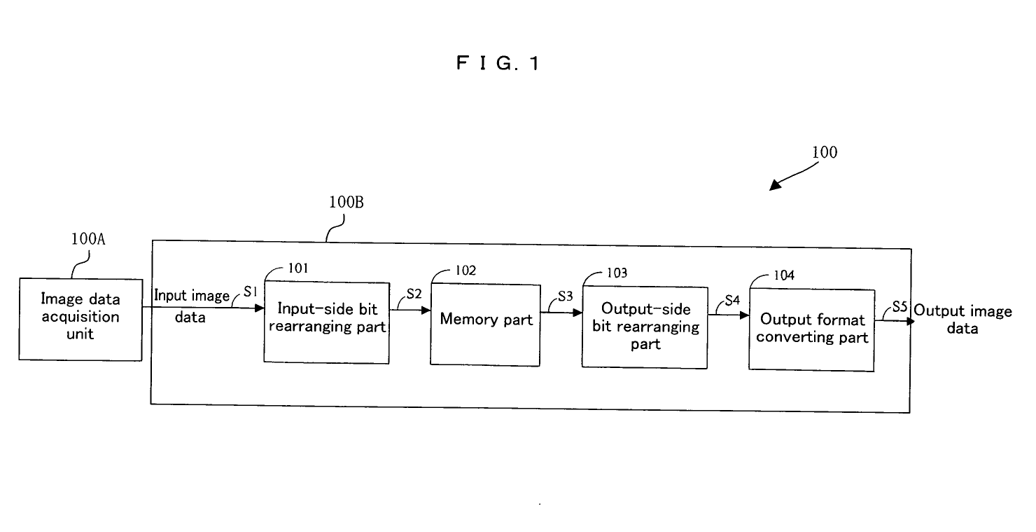

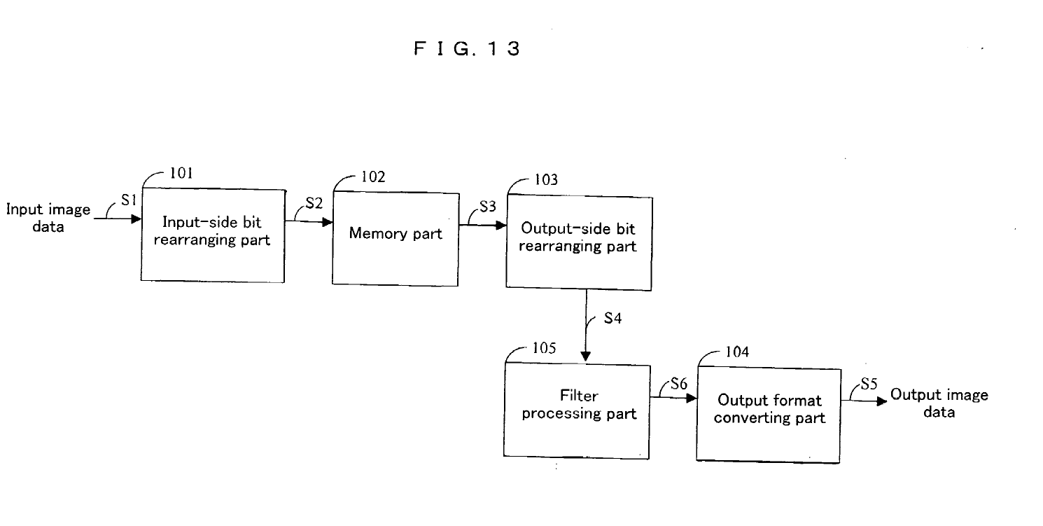

FIG. 13 shows an image processing system according to a modification example of the present invention. The same reference numerals are applied to the same components as those of the above-described embodiment, and the descriptions thereof are omitted. In this modification example, as shown in FIG. 13, added is a structure for performing filter processing in of filter processing part 105 at the time of reading out an image. Data S6 supplied to the output format converting part 104 is generated through the filter processing part 105. Other structures are constituted in the same manner as the case shown in FIG. 1-FIG. 12.

Filter processing is the processing for performing arithmetic operation such as “Y=aA+bB+cC+dD” in order to obtain the output Y, for example, provided that the input pixel data are referred to as A, B, C, D, and the coefficients are a, b, c, and d. The TAP number in this case is four. The TAP number is the number of input pixels required for obtaining one-pixel output through the filter processing. Noise reduction processing, contour emphasis processing and the like can be carried out through the filter processing.

The data of horizontal M-pixels×vertical N-pixels can be obtained by a readout access to a single address. When the rotation processing is carried out through rearranging the output, the data of horizontal N-pixels×vertical M-pixels can be obtained. In the case of N=M>1, since there is no change in the number of horizontal pixels and the number of vertical pixels which can be read out by an access to a single address even if an image is being rotated, it is possible to perform the same high-speed processing as the case without rotation. That is, in the case of N=M, since there is no difference between the pixel number in the vertical direction and the pixel number in the horizontal direction handled by an access to a single address even after rotation, the same high-speed processing can be performed in both the case with rotation and the case without rotation. Since the processing of M×N pixels can be performed by an access to a single address, high-speed processing can be achieved in the filter processing with a large TAP number.

### MODIFICATION EXAMPLE 2

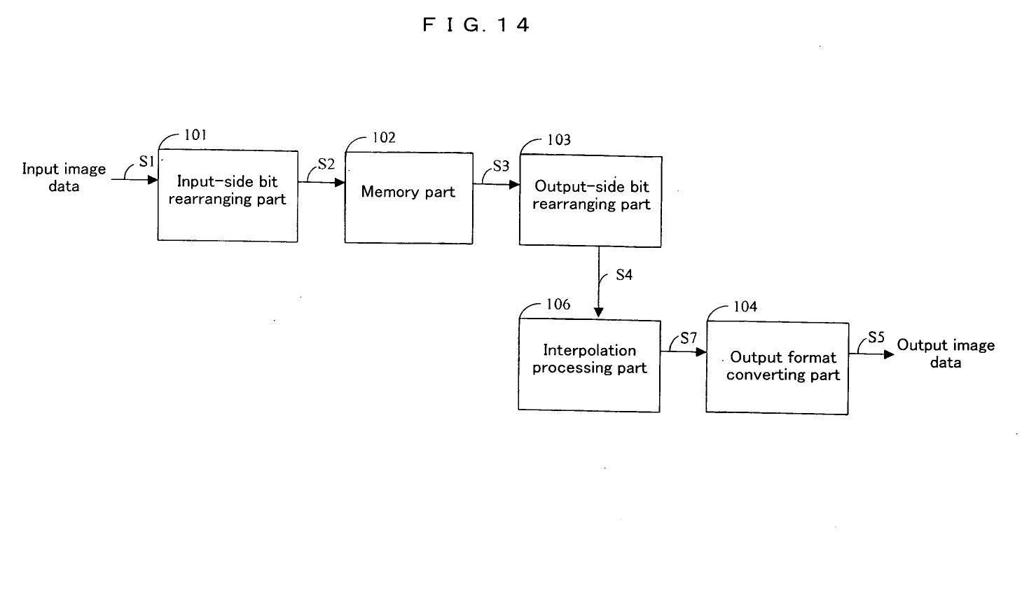

FIG. 14 shows an image processing system according to another modification example of the present invention. The same reference numerals are applied to the same components as those of the above-described embodiment, and the descriptions thereof are omitted. In this modification example, added is a structure for performing interpolation processing of the pixels in interpolation processing part 106 at the time of reading out an image, as shown in FIG. 14. Data S7 supplied to the output format converting part 104 is generated through the filter processing part 106. Other structures are constituted in the same manner as the case shown in FIG. 1-FIG. 12.

Interpolation processing is the processing for interpolating a pixel between the neighboring pixels by using the peripheral pixels, for example, in zooming or the like. The simplest interpolation, i.e. linear interpolation, will be described herein. When there is the image data with the luminance A and the luminance B, and a formula for performing interpolation of C that is away from A by the distance of a and away from B by the distance of b, can be expressed with an equation of “C=bA+aB/(a+b)”. In this case, C is interpolated from the two pixels, A and B, so that the number of TAP is two.

Like the case of the filter processing, arithmetic operation such as “Y=aA+bB+cC+dD - - - ” is carried out in the zoom processing. That is, the filter processing, reduction zoom processing, and enlargement zoom processing can be achieved by changing the coefficients a, b, c, d and changing the skipping interval of the output pixels. Since M×N pixels can be dealt with an access to a single address, a large number of arithmetic operations can be carried out at a high speed. Therefore, like the case of the filter processing, high-speed interpolation processing in the reduced zoom and the enlarged zoom can be performed. Through the interpolation processing, it becomes possible to perform the zoom processing with less deterioration in the picture quality.

### MODIFICATION EXAMPLE 3

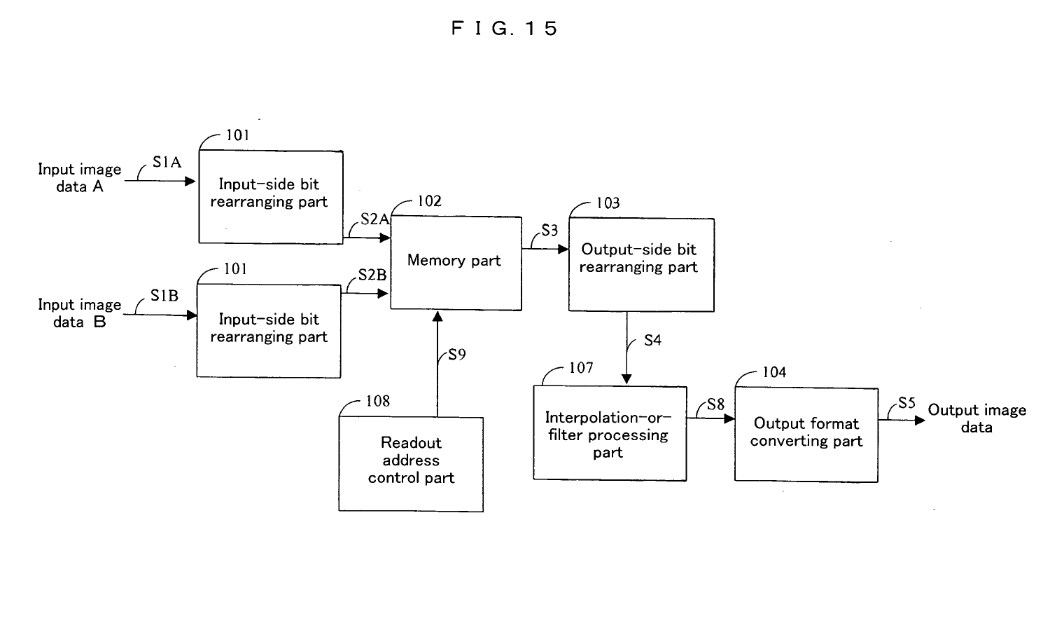

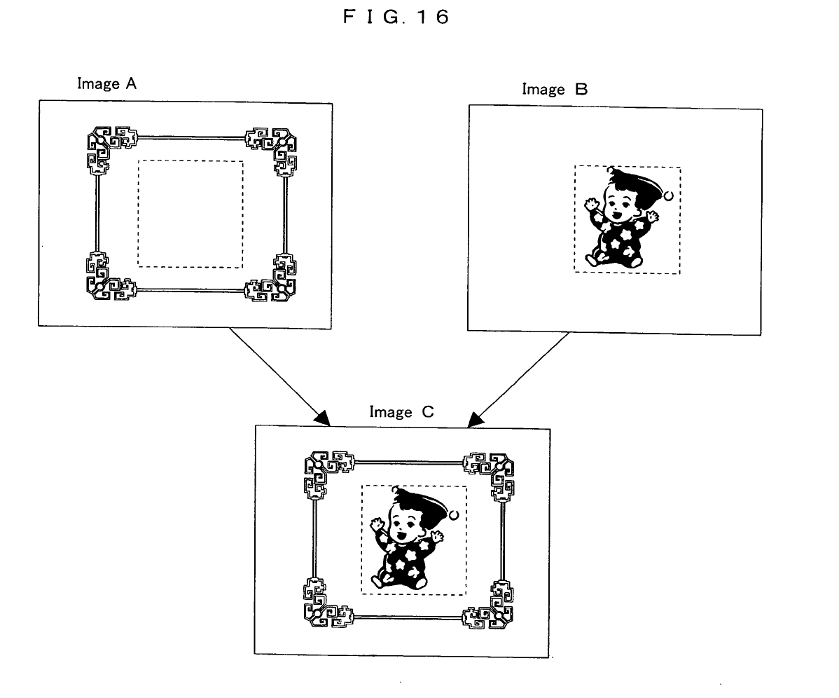

FIG. 15 and FIG. 16 show an image processing system according to yet another modification example of the present invention. The same reference numerals are applied to the same components as those of the above-described embodiment, and the descriptions thereof are omitted. In this modification example, image data is read out from a plurality of memory addresses, and superimposing processing of the images is carried out by making selection to perform either image display. Other structures are constituted in the same manner as the case shown in FIG. 1-FIG. 12.

Referring to FIG. 15, the superimposing processing of the images will be described. First, the input image data A is written to the memory part 102. Then, the image input data B is written to an unused address of the memory part 102. In reading out the image data from the memory part 102, either the address corresponding to the image data A or the address corresponding to the address B is selected based on a control signal S9 from the readout address control part 108. Further, in reading out the image data, pixel interpolation processing or filter processing is carried out by an interpolation-or-filter processing part 107 to obtain data S8 for the output format converting part 104.

An example of the effect obtained by performing the image superimposing processing will be described referring to FIG. 16. It is controlled so that the readout address control part 108 selects the image data A in the outer side of a dotted-line square of FIG. 16, and selects the image data B in the inner side of the dotted-line square. In this case, assuming that the image data A is a frame and the image data B is a person, a human image C within the frame can be obtained as the output image.

### MODIFICATION EXAMPLE 4

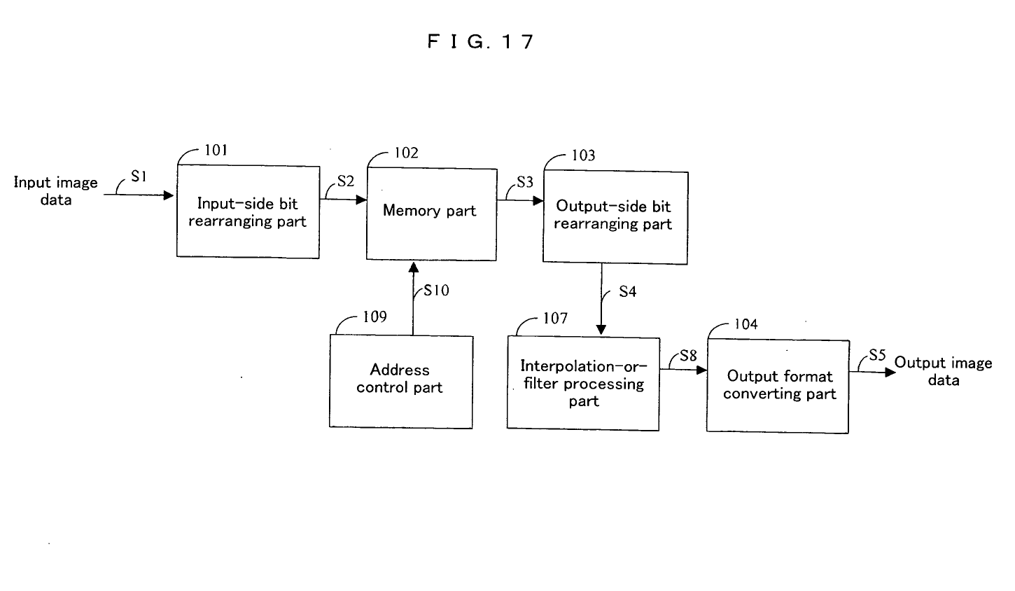

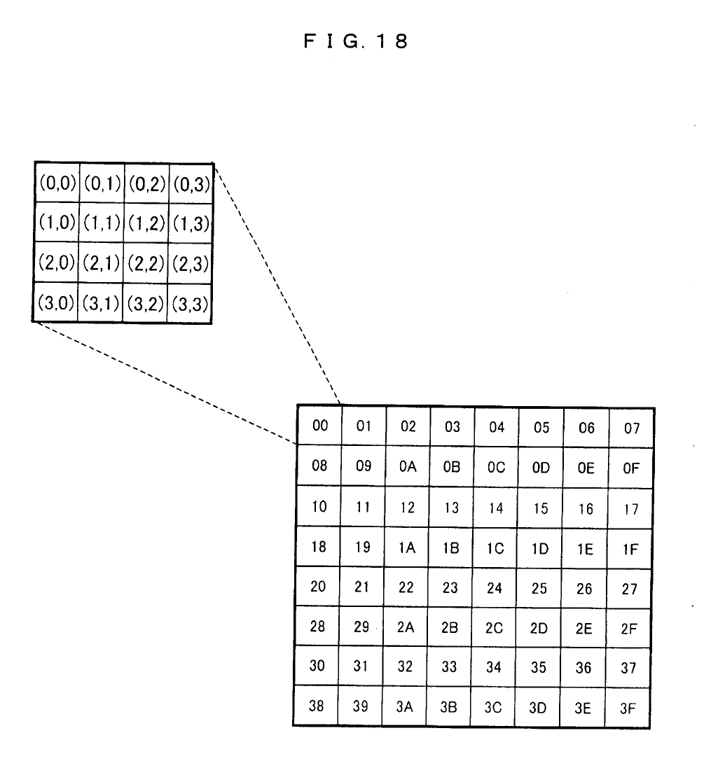

FIG. 17 and FIG. 18 show an image processing system according to yet another modification example of the present invention. The same reference numerals are applied to the same components as those of the above-described embodiment, and the descriptions thereof are omitted. Each of the above-described examples has been described referring to the case of handling M×N pixels per address. In this modification example, however, a large image data is handled by using a plurality of addresses.

It is now considered with respect to the case of handling 1024 (=32×32) pixels as shown in FIG. 18. The 1024 (=32×32) pixels are divided by 8 in the horizontal direction and the vertical direction respectively to be sectioned into sixty-four small blocks of 4×4 pixels. In an address control part 109 of FIG. 17, the first small block of 4×4 pixels at the upper-left corner is corresponded to the memory address 0. Then, the next small block of 4×4 pixels on the right side thereof is corresponded to the memory address 1. Thereafter, the small blocks are corresponded until the memory address 3F (63 in the decimal system) at the lower-right corner. After corresponding the memory blocks to the memory addresses in order of precedence at the address control part 109 in this manner, the image data is read out from the memory part 102 based on control signal S10 from the retrieving address control part 109. Herewith, a large image can be handled.

### MODIFICATION EXAMPLE 5

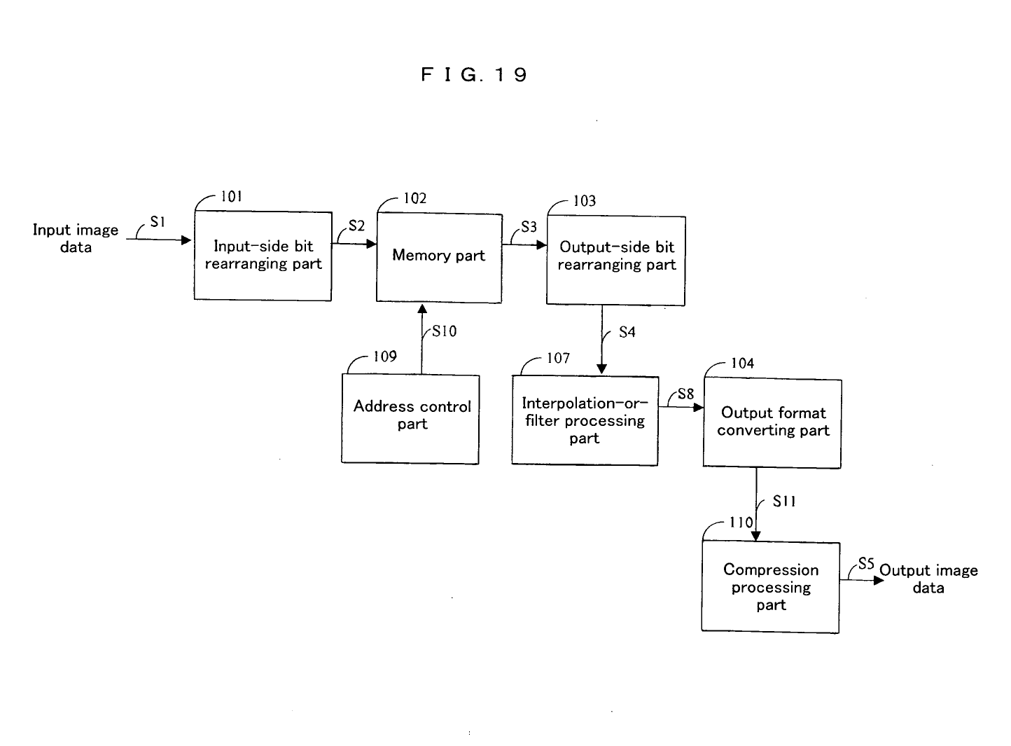

FIG. 19-FIG. 25 show an image processing system according to yet another modification example of the present invention. The same reference numerals are applied to the same components as those of the above-described embodiment, and the descriptions thereof are omitted. This example deals with compression-processed (JPEG or MPEG) image data.

Assuming that the data per a single address consists of horizontal 4-pixels×vertical 4-pixels, the image data by four addresses, eight addresses, or sixteen addresses becomes the data of horizontal 8-pixels×vertical 8-pixels, horizontal 8-pixels×vertical 16-pixels, or horizontal 16-pixels×vertical 16-pixels. The JPEG or MPEG image data is handled in the readout side by utilizing the image size without change.

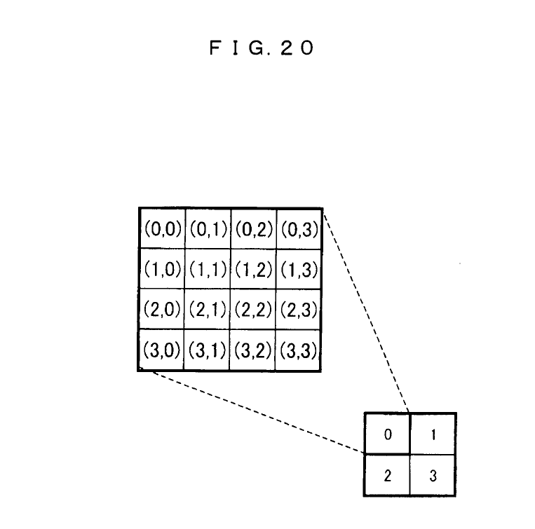

As shown in FIG. 20, 64 pixels (horizontal 8-pixels×vertical 8-pixels) are divided by 2 in the horizontal direction and the vertical direction respectively to be sectioned into four small blocks of 4×4 pixels. It is considered with respect to the case of the data with pixels of horizontal 8-pixels×vertical 8-pixels consisting of four addresses, provided that the data of horizontal 4-pixels×vertical 4-pixels is the data by a single address.

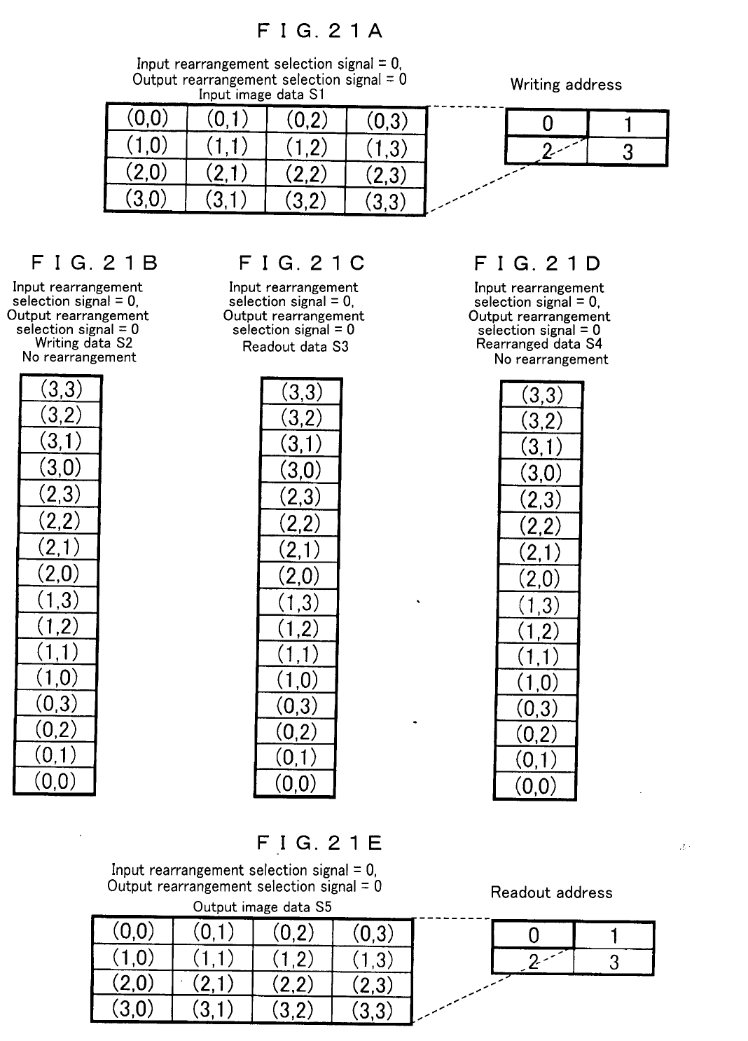

First, referring to FIG. 21, described is the case without the inversion processing and without the rotation processing. At the address control part 109 of FIG. 17, the first small block of 4×4 pixels at the upper-left corner shown in FIG. 21A and FIG. 21E is corresponded to the memory address 0, and the next small block of 4×4 pixels at the upper-right corner is corresponded to the memory address 1. Then, the small block of 4×4 pixels at the lower-left corner is corresponded to the memory address 2 and, at last, the small block of 4×4 pixels at the lower-right corner is corresponded to the memory address 3. In this manner, the data of horizontal 8-pixels×vertical 8-pixels without inversion processing and without rotation processing can be obtained. Data S11 obtained thereby receives JPEG processing or MPEG processing at a compression processing part 110 shown in FIG. 19.

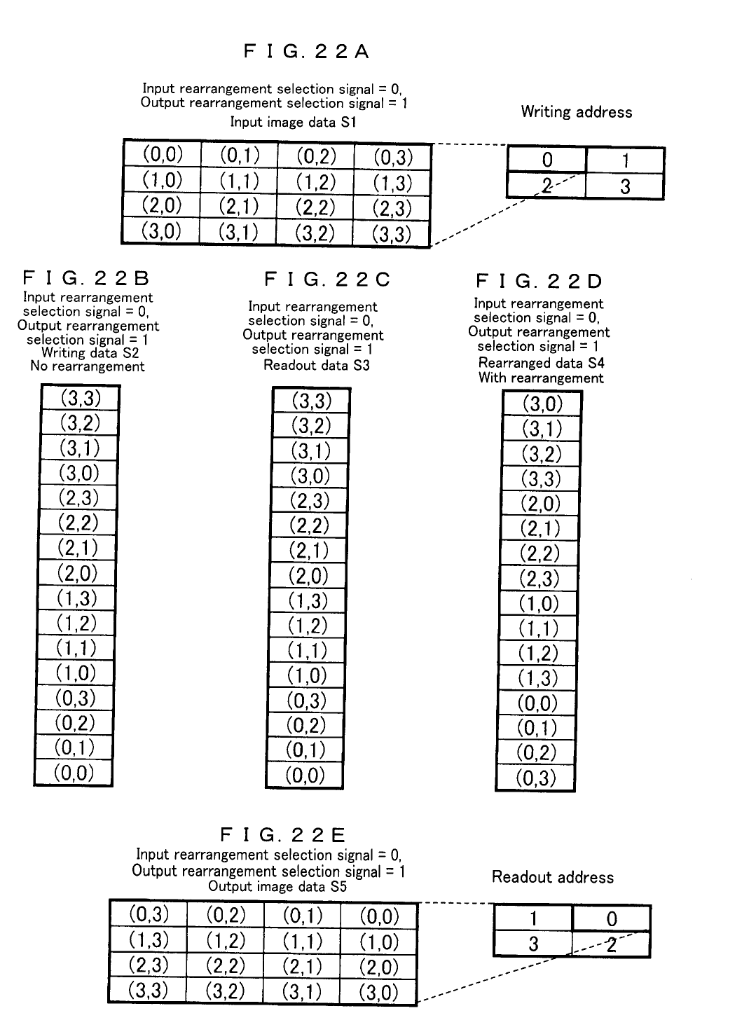

Next, referring to FIG. 22, it is described about the case wherein the right-and-left inversion processing and the writing data rearranging processing are performed, and the readout data rearranging processing is not done. First, the operation of the address control part 109 will be described. As shown in FIG. 22A, it is the same condition even in the writing action as the condition shown in FIG. 21A. The condition in readout operation is as shown in FIG. 22E. That is, the first small block of 4×4 pixels at the upper-left corner is corresponded to the memory address 1, and the next small block of 4×4 pixels at the upper-right corner is corresponded to the memory address 0. Then, the next small block of 4×4 pixels at the lower-left corner is corresponded to the memory address 3 and, at last, the small block of 4×4 pixels at the lower-right corner is corresponded to the memory address 2. In this manner, the data of horizontal 8-pixels×vertical 8-pixels that is inverted in between the left and the right, can be obtained. Data S11 obtained thereby receives JPEG processing or MPEG processing at the compression processing part 110.

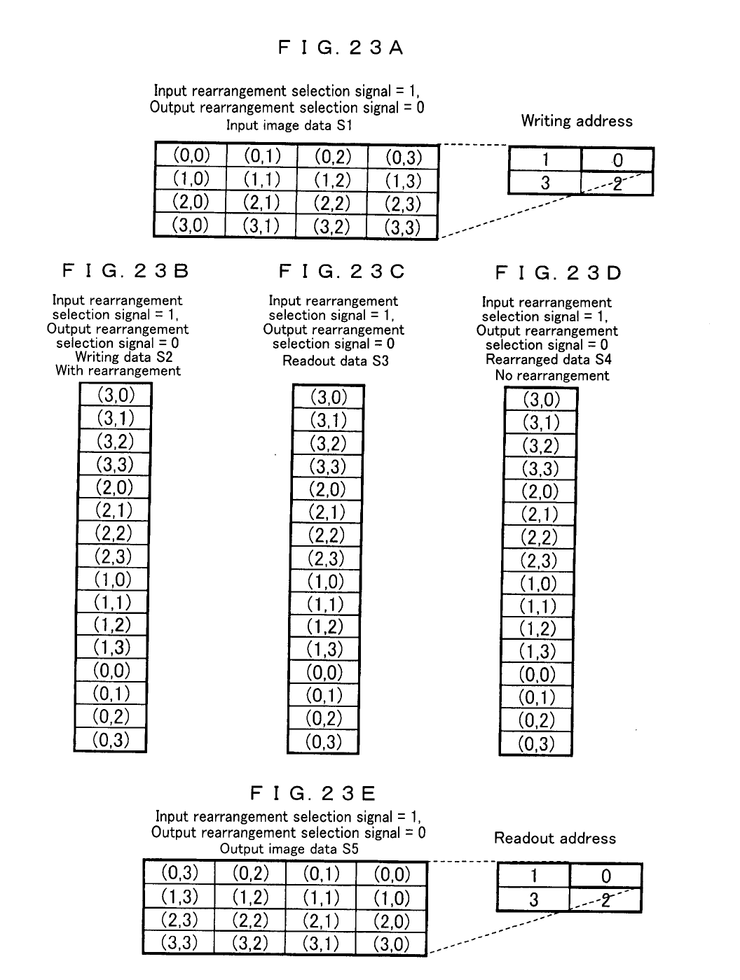

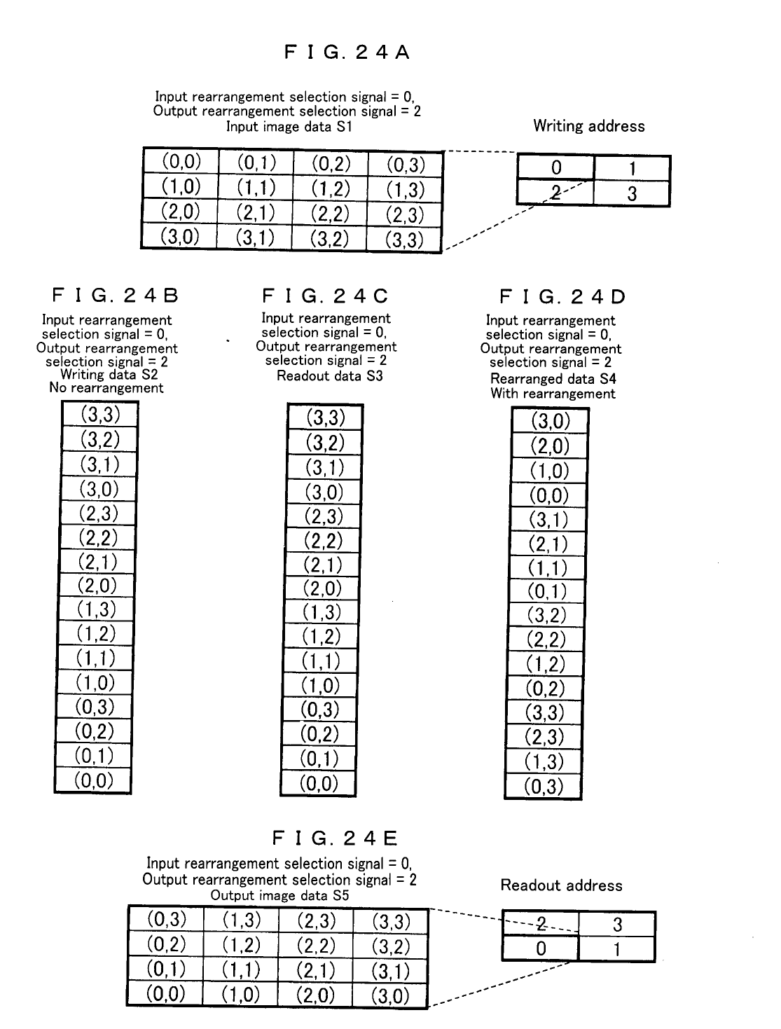

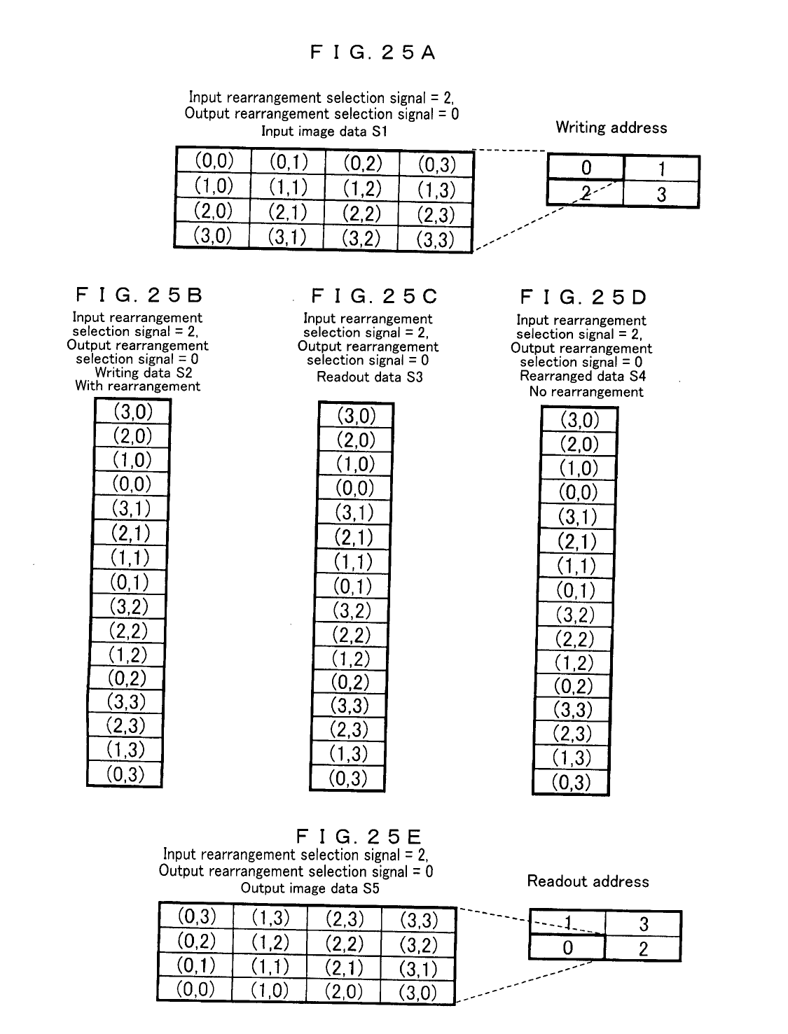

FIG. 23 shows the operations of the case wherein right-and-left inversion processing and writing data rearranging processing are performed, and readout data rearranging processing is not done. FIG. 24 shows the operations of the case wherein 90-degree rotation processing is performed, writing data rearranging processing is not performed, and readout data rearranging processing is done. FIG. 25 shows the operations of the case wherein 90-degree rotation processing and writing data rearranging processing are performed, and readout data rearranging processing is not done.

In this manner described above, the present invention can also be applied to the compression processing (MPEG, JPEG).

The present invention has been described in detail referring to the most preferred embodiments. However, various combinations and modifications of the components are possible without departing from the spirit and the broad scope of the appended claims.

What is claimed is:

1. An image processing system, comprising:
a built-in type memory in which number of bits per address is L×M×N bits or more, where L is an integer of 1 or larger, M is an integer of 2 or larger, and N is an integer of 2 or larger; and
a bit rearranging part which performs rearrangement of bits within a same address by a set of L-bits, in order to perform inversion or rotation of image data of M×N pixels on either of a data writing side or a data readout side of said memory part, or on both of those sides.

2. The image processing system according to claim 1, wherein said L-bits indicate luminance signals, color signals, or a combination of a luminance signal and a color signal.

3. The image processing system according to claim 1, further comprising a filter processing part for performing filter processing to said image data on said data readout side of said memory part.

4. The image processing system according to claim 1, further comprising an interpolation processing part for performing interpolation processing to said image data on said data readout side of said memory part.

5. The image processing system according to claim 1, wherein said image data is read out from a plurality of memory addresses of said memory part, and superimposing processing of said image data is carried out.

6. The image processing system according to claim 1, wherein, provided that k is an integer of 1 or larger, inversion processing or rotation processing of said image data by k-number of addresses is carried out on either of said data writing side or said data readout side, or on both of those sides.

7. The image processing system according to claim 6, wherein:
said image data is JPEG or MPEG image data;
said image data by said k-number of addresses is said image data consisting of 8×8, 8×16, or 16×16 pixels; and
inversion processing or rotation processing of said image data is performed on said data readout side of said memory part.

8. A video device, comprising an image data acquisition unit for obtaining said image data, and said image processing system according to claim 1.
